(19) United States
(12) Patent Application Publication
(10) Pub. No.: US 2025/0383045 A1
(43) Pub. Date: Dec. 18, 2025

(54) CAMERA SUPPORT FOR LOW-ANGLE SHOOTING

(71) Applicants: Kuang CHEN, New Taipei City (TW); Wen-Pin HUANG, Taichung City (TW)

(72) Inventors: Kuang CHEN, New Taipei City (TW); Wen-Pin HUANG, Taichung City (TW)

(21) Appl. No.: 18/743,801

(22) Filed: Jun. 14, 2024

(51) Int. Cl. F16M 11/12; G03B 17/56

(52) U.S. Cl. CPC F16M 11/126; G03B 17/561; F16M 2200/021

(57) ABSTRACT

A camera support for low-angle shooting includes a fixing base, a rotatable seat, a swingable seat, a shock absorber, a first stopper, and a second stopper. With the rotatable seat and the first stopper, a user may control the camera to rotate by 360 degrees and to stop at any position during the 360-degree rotation. With the swingable seat, the shock absorber and the second stopper, the user may control the camera to swing forward and rearward and to stop at any swinging angle. With the shock absorber, the swingable seat is limited to a constant swing speed for the user to easily shoot photos while the camera moves upward and downward at constant speed. The swingable seat also includes a quick-release mechanism for a dovetail plate at a bottom of the camera to be installed on the camera support with reduced time and complexity.

### FIELD OF THE INVENTION

The present invention relates to a camera support for low-angle shooting, and more particularly, to a camera support that enables a user to adjust camera shooting angles at the same speed.

### BACKGROUND OF THE INVENTION

A photographic artwork comes from a photographer's good skill and unique creation. The photographer can capture unique and lively picture through ingenious layout, adequate angle setting, and careful observation to give the picture rich story and feeling.

A camera support plays a significantly important role in presenting highly professional photographic artworks. A good camera support enables constant stability in the process of photographing to ensure desired clearness and smoothness of the captured images. Stability is particularly important when capturing the images of moving targets or taking pictures at special angles. Good camera support not only provides flexible angle adjustment, but also includes a large-scale cantilever support for the photographers to shoot from both high angle and low angle, providing them with even wider and free space in taking pictures.

Presently, there is a camera support designed and manufactured for low-angle shooting. This type of camera support allows the camera to shoot from a very low angle and is freely rotatable horizontally and vertically. Compared to the large-scale cantilever camera support, the low-angle camera support is more easily controllable and has a small volume.

However, the angular adjustment of the low-angle camera support is a challenge to the photographer's ability in controlling the camera stably, and the captured images would be unclear or even lousy if the camera could not be controlled stably to move between high and low shooting angles at the same speed.

### SUMMARY OF THE INVENTION

A primary object of the present invention is to improve the present camera support for low-angle shooting, so that the camera support is more stable and easier for use, allowing inexperienced people to take good pictures with stably changed speed between high and low shooting angles.

Another object of the present invention is to add a quick-release mechanism to the camera support to reduce the time and complexity of installing the camera on the camera support.

To achieve the above and other objects, the camera support for low-angle shooting according to the present invention includes a fixing base, a rotatable seat, a swingable seat, a shock absorber, a first stopper, and a second stopper.

The rotatable seat includes a rotating plate mounted to a top of the fixing base, two connection plates located at two opposite sides of the rotating plate, and a first pivotal section extended upward from the rotating plate. The swingable seat includes a supporting plate and two guiding plates located at two opposite sides of the supporting plate. The supporting plate is provided with a fixing mechanism for installing a dovetail plate, and a second pivotal section extended downward from the supporting plate. The two guiding plates are movably connected to the two connection plates respectively, such that the swingable seat is swingable reciprocatingly along a swing path, and a receiving space is defined between the supporting plate and the rotating plate and visible from a front side and a rear side of the swingable seat. The shock absorber is located in the receiving space and pivotally connected to between the first pivotal section and the second pivotal section, such that the shock absorber and the swingable seat swing synchronously. The first stopper is connected to the rotatable seat, such that the rotatable seat can switch between a first movable state and a first locked state. The rotatable seat is freely rotatable in the first movable state, and the rotatable seat is immovable in the first locked state. The second stopper is connected to one of the two connection plates, such that the swingable seat can switch between a second movable state, and a second locked state. The swingable seat is freely movable in the second movable state, and the swingable seat is immovable in the second locked state.

When the swingable seat in the second movable state swings relative to the rotatable seat, the swingable seat is limited by the shock absorber to a constant swing speed.

The two guiding plates are provided on respective outer side with a curved rail matching the swing path and the two connection plates are provided on respective inner side with at least one rail roller for engaging with the curved rails. The swingable seat is swingable reciprocatingly along the swing path relative to the rail rollers through engagement of the rail rollers with the curved rails.

The two guiding plates respectively include a curved bottom surface extended along the swing path and the two connection plates are provided on respective inner side with at least one secondary roller for engaging with the curved bottom surfaces. The secondary rollers provide the swingable seat with an upward support, and the rail rollers and the secondary rollers always rotating in two opposite directions when the swingable seat is in the second movable state.

The curved bottom surfaces respectively include a limiting surface and a contacting surface. The limiting surfaces, the contacting surfaces, and the connection plates together define a groove capable of receiving a partial volume of the secondary rollers therein.

The fixing mechanism includes a clamping section and a quick-release handle linked to the clamping section. The clamping section is moved inward to clamp the dovetail plate in place when the quick-release handle is in a closed position; and the clamping section is moved outward to release the dovetail plate when the quick-release handle is in a loosened position. The quick-release handle includes an adjusting element that is adjustable by a user to change a clamping force exerted by the clamping section on the dovetail plate.

In a preferred embodiment, the shock absorber includes a piston cylinder, an extension rod, and a knob. The piston cylinder is pivotally connected to the first pivotal section to be swingable reciprocatingly relative to the first pivotal section. The extension rod has an end extended through the piston cylinder and another end connected to the second pivotal section. The knob is used to adjust a resistance to the extension rod when the extension rod moves in the piston cylinder, so as to change the swing speed of the swingable seat.

The supporting plate further includes an assembling section for connecting an operating handle. The assembling section includes a toothed locating disc and a packing member. The operating handle can be fixed to any angular position between the toothed locating disc and the packing member.

In the preferred embodiment, the first stopper includes a rotational section, a pivotally turnable section, and an abutting section. The rotational section and the abutting section are located at two opposite ends of the pivotally turnable section. When one of the two ends of the pivotally turnable section ascends, the other end of the pivotally turnable section descends at the same time. The rotational section is adjustable to move upward, such that the abutting section is moved downward to abut on the rotatable seat to stop the same from rotating.

The present invention is characterized in that the user can use the rotatable seat and the swingable seat to move the camera lens smoothly when the camera installed on the camera support is set to shoot from a low angle. And, with the aid of the shock absorber, the swingable seat is limited to swing at a constant swing speed, enabling the user to easily capture an image stably.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 is a top perspective view of a camera support for low-angle shooting according to a preferred embodiment of the present invention;

FIG. 2 is a bottom perspective view of the camera support for low-angle shooting according to the preferred embodiment of the present invention;

FIG. 3 is an exploded view of FIGS. 1 and 2;

FIG. 4A shows a quick release mechanism of the camera support for low-angle shooting according to the present invention in a loosening state;

FIG. 4B shows the quick release mechanism is in a tightening state;

FIGS. 5A and 5B show a shock absorber of the camera support for low-angle shooting according to the present invention being pulled when a swingable seat of the camera support for low-angle shooting is in a second movable state.

### DETAILED DESCRIPTION OF THE PREFERRED EMBODIMENTS

The present invention will now be described with a preferred embodiment thereof with reference to the accompanying drawings.

The camera support for low-angle shooting according to a preferred embodiment of the present invention is normally positioned on a flat ground for use. A dovetail plate can be installed on a top of the camera support and a camera is supported on the dovetail plate, so that a user is able to take a low-angle shot from a height very close to the ground with the camera aimed upward.

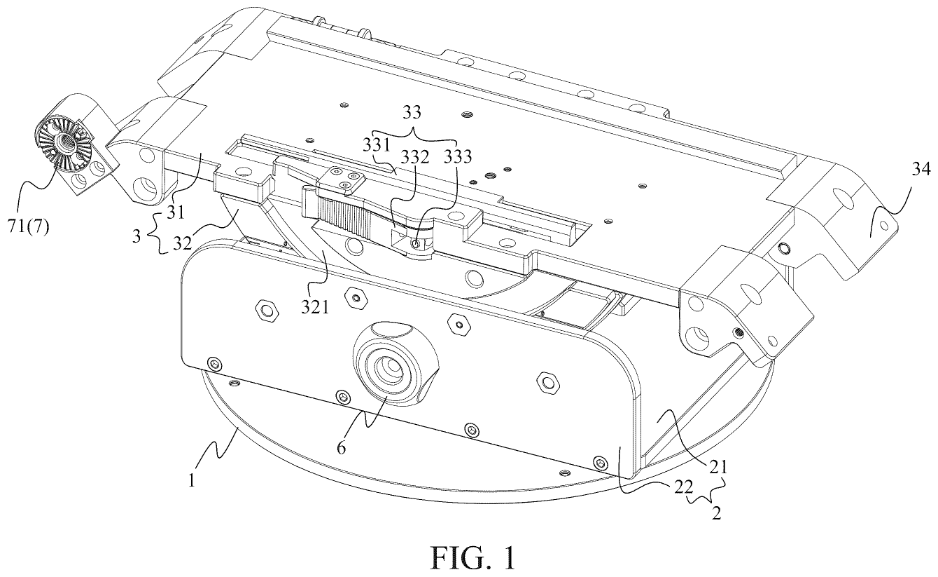

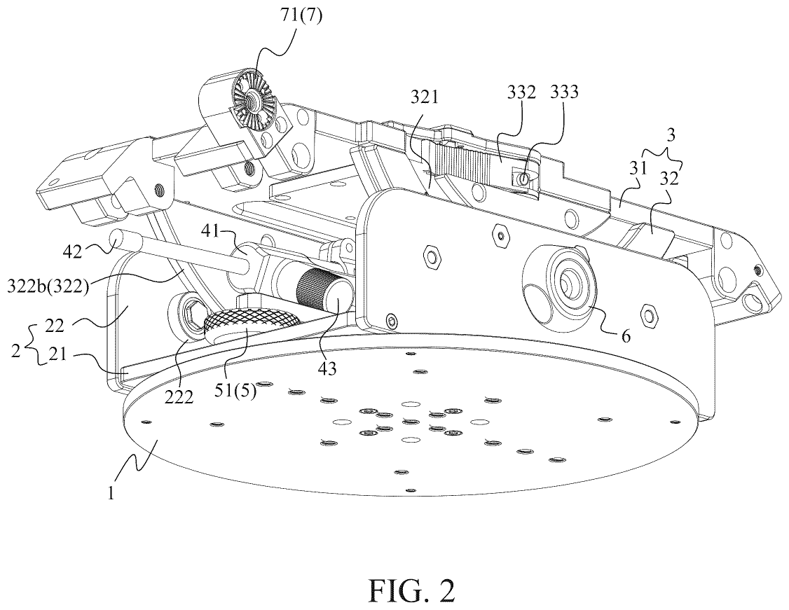

Please refer to FIGS. 1 and 2. The camera support for low angle shooting according to the present invention includes a fixing base 1, a rotatable seat 2, a swingable seat 3, a shock absorber 4, a first stopper 5, and a second stopper 6. The fixing base 1 includes a rotating member 11, and the rotatable seat 2 includes a rotating plate 21, two connection plates 22, and a first pivotal section 23 extending upward from the rotating plate 21. The rotating plate 21 is rotatably connected to the rotating member 11, and the two connection plates 22 are connected to two opposite sides of the rotating plate 21.

The swingable seat 3 includes a supporting plate 31 and two guiding plates 32 connected to and extended downward from two opposite sides of the supporting plate 31. The supporting plate 31 is provided with a fixing mechanism 33 for installing the dovetail plate thereon and a second pivotal section 34 extended downward from an end of the supporting plate 31. The two guiding plates 32 are movably connected to inner sides of the two connection plates 22, such that the swingable seat 3 can swing reciprocatingly along a swing path and a receiving space is defined between the supporting plate 31 and the rotating plate 21 and visible from a front and a rear side of the swingable seat 3.

The shock absorber 4 is located in the receiving space and pivotally connected to between the first pivotal section 23 and the second pivotal section 34, such that the shock absorber 4 and the swingable seat 3 swing synchronously. The first stopper 5 is connected to the rotatable seat 2, such that the rotatable seat 2 can switch between a first movable state, in which the rotatable seat 2 is freely rotatable, and a first locked state, in which the rotatable seat 2 is still and immovable. The second stopper 6 is connected to one of the two connection plates 22, such that the swingable seat 3 can switch between a second movable state, in which the swingable seat 3 is freely movable, and a second locked state, in which the swingable seat 3 is still and immovable.

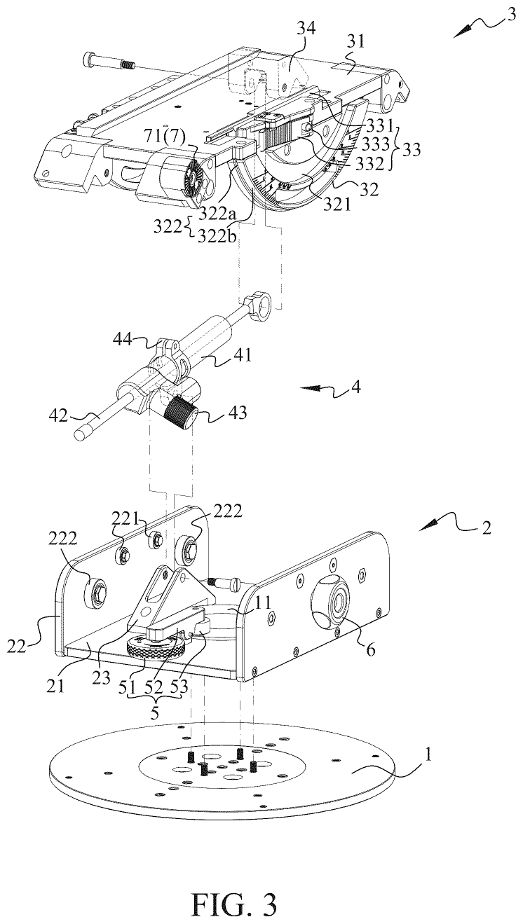

Please refer to FIG. 3. The two guiding plates 32 are provided on respective outer side with a curved rail 321 matching the swing path; and the two connection plates 22 are provided on respective inner side with at least one rail roller 221 for engaging with the curved rails 321. The rail rollers 221 are rotatable relative to the connection plates 22 but not movable relative to the connection plates 22. The swingable seat 3 can swing reciprocatingly along the swing path relative to the rail rollers 221.

The two guiding plates 32 respectively include a curved bottom surface 322 extended along the swing path; and the two connection plates 22 are provided on respective inner side with at least one secondary roller 222 for engaging with the curved bottom surfaces 322. The secondary rollers 222 provide the swingable seat 3 an upward support. When the swingable seat 3 is in the second movable state, the rail rollers 221 and the secondary rollers 222 always rotate in two opposite directions. The curved bottom surfaces 322 respectively include a limiting surface 322a and a contacting surface 322b in contact with outer sides of the secondary rollers 22. The limiting surfaces 322a, the contacting surfaces 322b, and the connection plates 22 together define a groove capable of receiving a partial volume of the secondary rollers 222 therein.

The curved rails 321 and the rail rollers 221 limit the swing path of the swingable seat 3; and the secondary rollers 222 enable the swingable seat 3 to swing smoothly and provide the swingable seat 3 with an upward support, such that the rotatable seat 2 can have increased loading capacity.

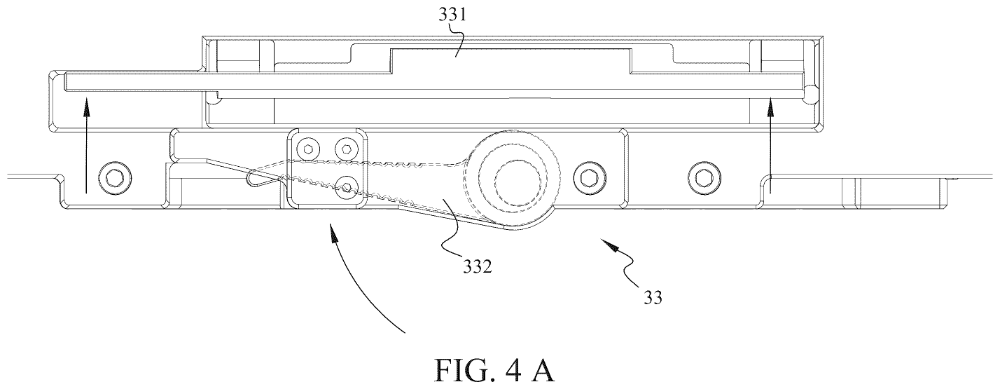

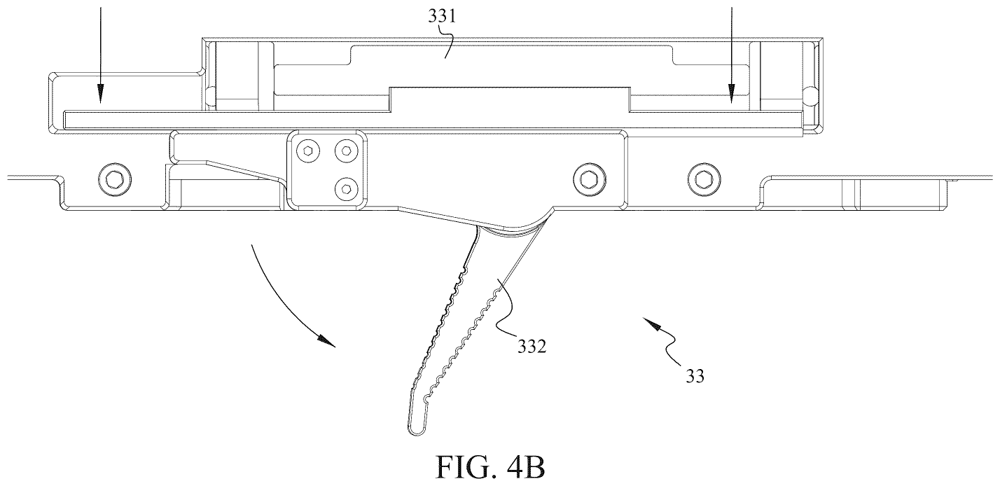

Please refer to FIGS. 4A and 4B. The fixing mechanism 33 includes a clamping section 331 and a quick-release handle 332 linked to the clamping section 331. When the quick-release handle 332 is in a tightening position as shown in FIG. 4B, the clamping section 331 is moved inward to clamp to the dovetail plate (not shown). On the other hand, when the quick-release handle 332 is in a loosening position as shown in FIG. 4A, the clamping section 331 is moved outward to release the dovetail plate. Further, as can be seen in FIG. 3, the quick-release handle 332 also includes an adjusting element 333. In the illustrated preferred embodiment, the user can insert a hand tool into the adjusting element 333 to adjust a clamping force exerted by the clamping section 331 on the dovetail plate.

Please refer to FIGS. 1, 2 and 3. The supporting plate 31 further includes an assembling section 7 that can have an operating handle (not shown) connected thereto. The assembling section 7 includes a toothed locating disc 71 and a packing member (not shown), such that the operating handle can be fixed to any angular position between the toothed locating disc 71 and the packing member. The user can manipulate the camera conveniently via the operating handle to control the camera to rotate horizontally and swing forward and rearward.

Please refer to FIG. 3. The first stopper 5 includes a rotational section 51, a pivotally turnable section 52, and an abutting section 53. The rotational section 51 and the abutting section 53 are located at two opposite ends of the pivotally turnable section 52. When one of the two ends of the pivotally turnable section 52 ascends, the other end of the pivotally turnable section 52 descends at the same time. The user may adjust the rotational section 51 to move it upward, so that the abutting section 53 is moved downward to abut on the rotatable seat 2 and stop the rotatable seat 2 from rotating.

Please refer to FIGS. 2 and 3. The shock absorber 4 includes a piston cylinder 41, an extension rod 42, a knob 43, and a connecting section 44. The connecting section 44 is located at a central area of the piston cylinder 41 and pivotally connected to the first pivotal section 23, such that the shock absorber 4 is swingable reciprocatingly relative to the first pivotal section 23. The extension rod 42 has an end extended through the piston cylinder 41 and another end connected to the second pivotal section 34. With this arrangement, the swingable seat 3 swinging reciprocatingly also pulls the extension rod 42, and is therefore limited to a certain swinging speed. The knob 43 is used to adjust a resistance to the extension rod 42 when the latter moves in the piston cylinder 41. That is, the swinging speed of the swingable seat 3 can be changed by the user via the knob 43

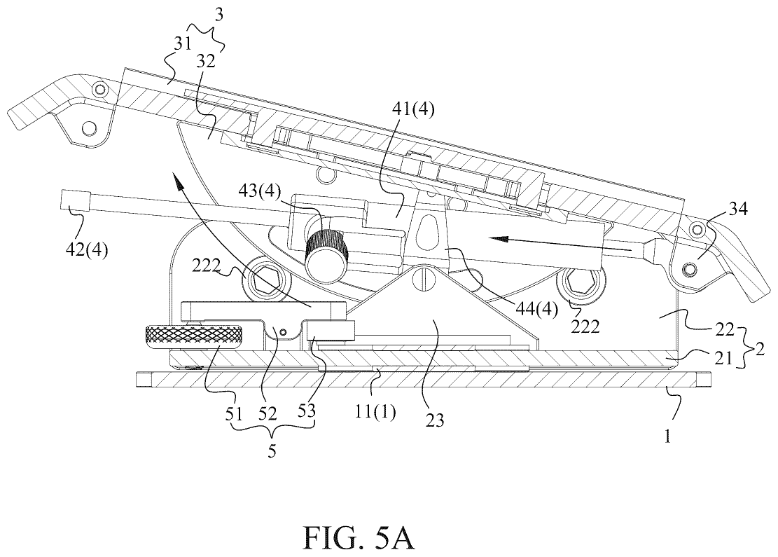

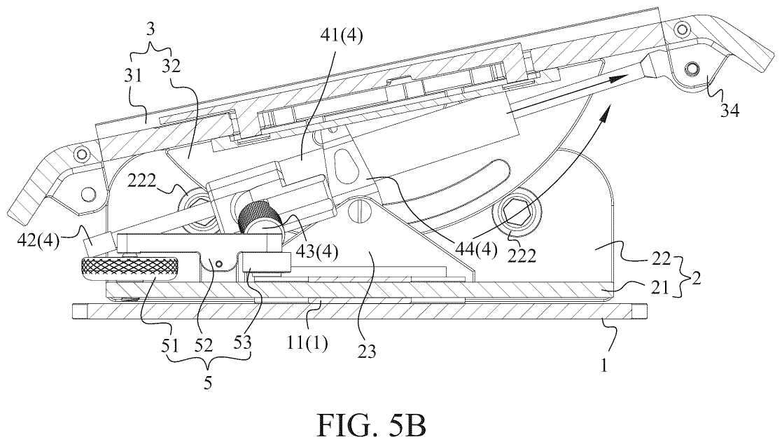

Please refer to FIGS. 5A and 5B. When the swingable seat 3 in the second movable state swings relative to the rotatable seat 2, the swingable seat 3 will swing reciprocatingly between a first position, in which a right end of the swingable seat having the second pivotal section 34 is descended as shown in FIG. 5A, and a second position, in which the end of the swingable seat having the second pivotal section 34 is ascended as shown in FIG. 5B.

Please refer to FIG. 5A. When the left end of the swingable seat 3 opposite to the second pivotal section 34 ascends gradually, the second pivotal section 34 at the right end of the swingable seat 3 approaches the first pivotal section 23 and pulls the extension rod 42. Please refer to FIG. 5B. When the right end of the swingable seat 3 ascends gradually, the first pivotal section 23 brings a right end of the shock absorber 4 to ascend slowly, and the second pivotal section 34 is moved away from the first pivotal section 23 at the same time.

Therefore, in the swinging process of the swingable seat 3, the second pivotal section 34 moves toward and away from the first pivotal section 23 repeatedly, and accordingly, the shock absorber 4 is continuously pulled by the swingable seat 3 is in the second movable state to thereby limit the swingable seat 3 to swing at a constant speed. With this arrangement, the camera used to shoot low-angle photos can be turned upward and downward at constant speed, and the user can get stable pictures without the need of manually adjusting the speed of turning the camera upward and downward.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A camera support for low-angle shooting, comprising:
a fixing base;
a rotatable seat including a rotating plate rotatably connected to a top of the fixing base, two connection plates connected to two opposite sides of the rotating plate, and a first pivotal section extending upward from the rotating plate;
a swingable seat including a supporting plate and two guiding plates located at two opposite sides of the supporting plate; the supporting plate being provided with a fixing mechanism for installing a dovetail plate, and a second pivotal section extended downward from an end of the supporting plate; the two guiding plates being movably connected to the two connecting plates respectively, such that the swingable seat is swingable reciprocatingly along a swing path, and a receiving space is defined between the supporting plate and the rotating plate and is visible from a front side and a rear side of the swingable seat;
a shock absorber being located in the receiving space and pivotally connected to between the first pivotal section and the second pivotal section, such that the shock absorber and the swingable seat swing synchronously;
a first stopper being connected to the rotatable seat, such that the rotatable seat can switch between a first movable state and a first locked state The rotatable seat is freely rotatable in the first movable state, and the rotatable seat is immovable in the first locked state; and
a second stopper being connected to one of the two connection plates, such that the swingable seat can switch between a second movable state and a second locked state The swingable seat is freely movable in the second movable state, and the swingable seat is immovable in the second locked state; and
wherein the swingable seat is limited by the shock absorber to swing at a constant speed when the swingable seat is in the second movable state and swings relative to the rotatable seat.

2. The camera support for low-angle shooting as claimed in claim 1, wherein the two guiding plates are provided on respective outer side with a curved rail matching the swing path, and the two connection plates being provided on respective inner side with at least one rail roller for engaging with the curved rails; and the swingable seat being swingable reciprocatingly along the swing path relative to the rail rollers through engagement of the rail rollers with the curved rails.

3. The camera support for low-angle shooting as claimed in claim 2, wherein the two guiding plates respectively include a curved bottom surface extended along the swing path; the two connection plates being provided on respective inner side with at least one secondary roller for engaging with the curved bottom surfaces to provide the swingable seat with an upward support, and the rail rollers and the secondary rollers always rotating in two opposite directions when the swingable seat is in the second movable state.

4. The camera support for low-angle shooting as claimed in claim 3, wherein the curved bottom surfaces respectively include a limiting surface and a contacting surface, and the limiting surfaces, the contacting surfaces, and the connection plates together defining a groove capable of receiving a partial volume of the secondary rollers therein.

5. The camera support for low-angle shooting as claimed in claim 1, wherein the fixing mechanism includes a clamping section and a quick-release handle linked to the clamping section; the clamping section being moved inward to clamp the dovetail plate in place when the quick-release handle is in a tightening position; and the clamping section being moved outward to release the dovetail plate when the quick-release handle is in a loosening position.

6. The camera support for low-angle shooting as claimed in claim 5, wherein the quick-release handle includes an adjusting element being adjustable by a user to change a clamping force exerted by the clamping section on the dovetail plate.

7. The camera support for low-angle shooting as claimed in claim 1, wherein the shock absorber includes a piston cylinder, an extension rod, and a knob; the piston cylinder being pivotally connected to the first pivotal section to be swingable reciprocatingly relative to the first pivotal section; the extension rod having an end extended through the piston cylinder and another end connected to the second pivotal section; and the knob being used to adjust a resistance to the extension rod when the extension rod moves in the piston cylinder, so as to change the swing speed of the swingable seat.

8. The camera support for low-angle shooting as claimed in claim 1, wherein the supporting plate further includes an assembling section for connecting an operating handle; the assembling section including a toothed locating disc and a packing member, and the operating handle being fixable to any angular position between the toothed locating disc and the packing member.

9. The camera support for low-angle shooting as claimed in claim 1, wherein the first stopper includes a rotational prot, a pivotally turnable section, and an abutting section; the rotational section and the abutting section being located at two opposite ends of the pivotally turnable section; and wherein when one of the two ends of the pivotally turnable section ascends, the other end of the pivotally turnable section descends at the same time; and the rotational section being adjustable to move upward, such that the abutting section is moved downward to abut on the rotatable seat to stop the same from rotating.
